(19) United States
(12) Patent Application Publication
(10) Pub. No.: US 2005/0086176 A1
(43) Pub. Date: Apr. 21, 2005

(54) Method and apparatus for loan management using an electronic portal

(76) Inventors: John Dahlgren, Aberdeen, SD (US); Rod Dobberpuhl, Aberdeen, SD (US); Steve Mitzel, Aberdeen, SD (US); Steve Kohles, Aberdeen, SD (US); Patti Waterman, Aberdeen, SD (US)

Correspondence Address: Howrey Simon Arnold & White, LLP, 301 Ravenswood Avenue, Box 34, Menlo Park, CA, 94025, US

(21) Appl. No.: 10/903,440

(22) Filed: Jul. 30, 2004

Related U.S. Application Data
(60) Provisional application No. 60/492,234, filed on Jul. 31, 2003.
(60) Provisional application No. 60/567,302, filed on Apr. 30, 2004.

(51) Int. Cl. H04L 9/00

(52) U.S. Cl. 705/64

(57) ABSTRACT

An electronic financial system and method for integrating those involved in financial transactions with the use of various forms of communication to increase the speed and ease of financial transactions. A portal used by the electronic financial system allows each entity associated with financial transactions to interact with the system. The portal uses any form of communication including wireless, cellular, satellite, Internet, television and local area network to communicate and share data with those involved in financial transactions. A database, accessible through the portal, is used by the system to store financial transaction data of those involved in financial transactions. The financial transactions supported include student loans, automobile loans, consumer loans and home loans. The financial system uses novel methods to implement processes used to perform the financial transactions as well as to monitor the system.

### CROSS-REFERENCE TO RELATED APPLICATIONS This application claims priority to and incorporates by reference:

U.S. Provisional Patent Application No. 60/492,234 titled METHOD AND APPARATUS FOR LOAN MANAGEMENT USING AN ELECTRONIC PORTAL filed Jul. 31, 2003; and

U.S. Provisional Patent Application No. 60/567,302 titled METHOD AND APPARATUS FOR LOAN MANAGEMENT USING AN ELECTRONIC PORTAL filed Apr. 30,2004.

### BACKGROUND

Student loans, as well as other types of loans, are financial transactions used to provide money to people in need of funds. The current processes for implementing loans and other financial transactions are very much out-of-date. In an origination process, loans are typically applied for by the applicant filling out a paper loan application and manually submitting it to a bank or other loan application accepting agency. The paper loan application is then reviewed by a person responsible for approving the loan. After a loan is approved, the funds are distributed to the applicant/borrower or his/her school.

While the loan is outstanding, it is kept in an interim state. During this state, the loan processors and loan holders maintain the status of the loan. When the borrower's grace period expires, the loan is put into a repayment state. During repayment, the loan due date and balance are updated as the loan is being repaid. The loan's status is also updated if payments are deferred or if the loan defaults. Modifications to the status or state of the loan may be performed by workers looking and manipulating papers by hand or by entering data into a database. Further, communications among those involved in the loan process are performed through a myriad of different links. This method of financial transaction processing, modification and communication results in several inefficiencies.

The current art is deficient in several respects. The current art does not provide for a unified system to implement and monitor an entire financial transaction process on a computer system that is connected to the Internet or to other communication systems. Also, the current art does not provide for a system capable of implementing electronic communications to link entities involved in financial transactions, such as guarantors, borrowers, third-party recipients and lenders, either to one another or to such a unified system. In addition, the current art does not include a portal to connect all entities associated with a financial transaction to a single system. Additionally, the current art lacks a system providing a database to store and make available all of the financial transaction data for those involved in financial transactions. Further, the current art fails to provide methods, to implement on a financial transaction system, that allow the system to conduct and process all the steps of a financial transaction for all the entities involved in those financial transactions.

### SUMMARY

The present invention provides a system and method for conducting financial transactions, including transactions related to loans, over a network or any other communication link. The system and method include the ability to perform origination, repayment and interim loan processes. In an embodiment of the system and method, the present invention is directed towards processing student loans.

Integration of all the entities involved in financial transactions is also accomplished by the system and method of the present invention. The invention electronically connects entities involved in financial transactions such as lenders, borrowers, guarantors, and third-party beneficiaries to a unified system. The unified system allows these entities to obtain data related to the financial transactions from a central repository. It also permits the entities to perform all the steps related to financial transactions on the unified system, negating the need by each entity to integrate its system with the systems of all of the other entities.

A portal is implemented to integrate all of the entities involved with financial transactions to the system and method of the present invention. The portal provides simple integration to the system of the present invention by providing standardized interfaces to the system that are used by the entities involved in financial transactions. These standardized interfaces lower both the cost and the implementation time of integrating with the system and performing financial transactions. The portal further enhances the entities' abilities to retrieve and review data by permitting access to all data related to the implemented financial transactions.

The system and method of the present invention allow for an increase in the speed of transactions throughout the loan process. The system and method utilize a hierarchical data storage system and method to keep data in more easily accessed memory when the system and method determine that the data are being used more often. Further, the system and method enhance the speed of the transactions by connecting the various components of the system in optimal configurations.

The interconnectivity of the various modules in the system and method of the present invention is also advantageous. The interconnectivity permits the system and method to perform the transactions associated with loan processing on a single system. Further, the interconnectivity allows for the coordination and use of different formats of data associated with loans within the same system. The interconnectivity of the system also allows for optimization of the placement of modules within the system as well as methods incorporated in the system. For instance, the modules, such as data storage modules with different speeds, can be specifically located within the system to optimize the speed of data retrieval. Further, methods of the invention can be optimized to take advantage of the system's architecture. For instance, web sites may be connected to data storage modules to allow users to quickly modify or retrieve information located within the system.

The system and method of the invention also provide for automation of financial transaction processes. As steps of the financial transaction processes are incorporated into the system and method, users of the present invention will automatically be provided with useful information, allowing them to quickly perform these financial transactions processes. The additional information includes tips for streamlining a financial transaction process. The system also automatically provides users of the system with forms and data needed for the next step(s) in the process. The automation also includes the ability to track and monitor any financial transaction process to ensure that steps of the process are performed correctly.

The system and method use automatic monitoring to ensure that the financial transactions are processed properly. At each step, the system may perform a check to determine whether a transaction step is valid. Further, the system periodically monitors the process flow and data within the system to determine whether there are any discrepancies within the system. If the system discovers an error, it may either resolve the error or flag the error for further review by a human operator. The system is also capable of providing error notifications to the entities connected to the system.

The interconnections for the present invention may be accomplished through the use of the Internet or any other electronic or other network communications, such as wireless, cellular, satellite, television, local area network, or any combination thereof. The types of financial transactions serviced by the system and method, include student, automobile, consumer and home loans.

### BRIEF DESCRIPTION OF THE FIGURES

FIG. 1 is a flow diagram of a method for a loan origination process.

FIG. 2 is a flow diagram of a method for an interim loan process.

FIG. 3 is a flow diagram of a method for implementing a repayment process.

FIG. 4 is a flow diagram of a method for repayment form process.

FIG. 5 is a block diagram for a system for processing loans according to the invention.

FIGS. 6a and 6b are two embodiments of process flows into a database of a loan origination and credit review system.

FIGS. 7a and 7b are diagrams illustrating dataflow into and out of the invention.

### DETAILED DESCRIPTION

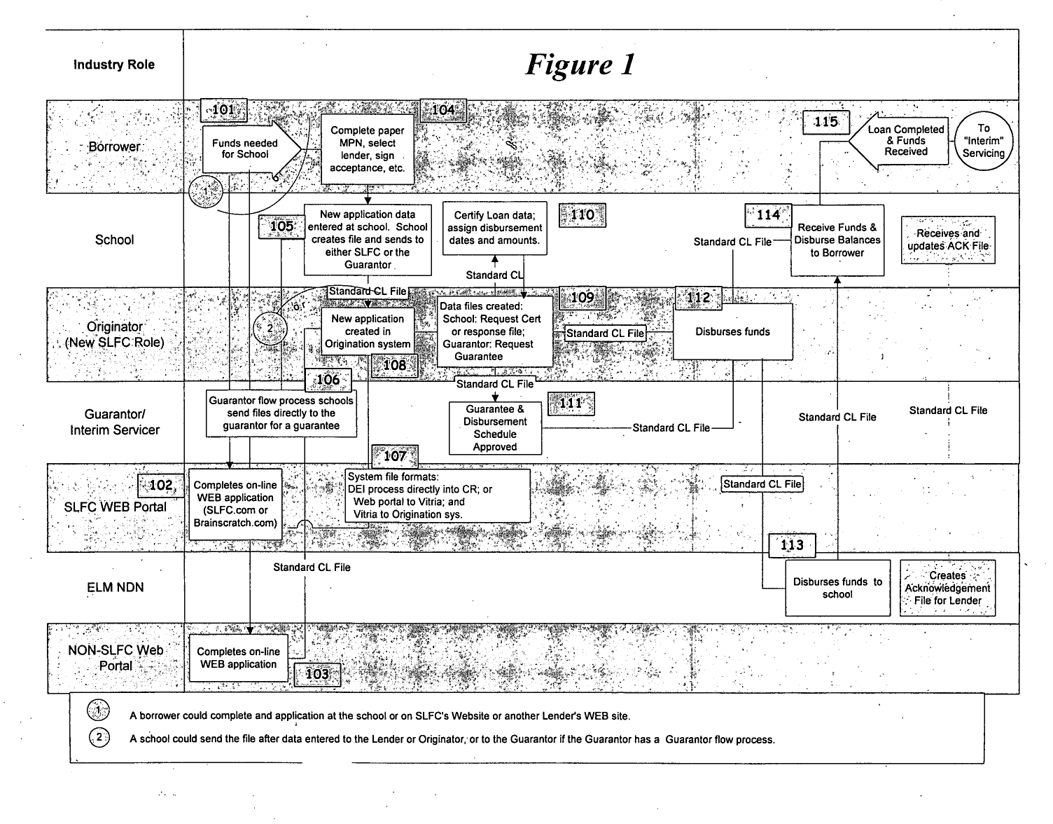

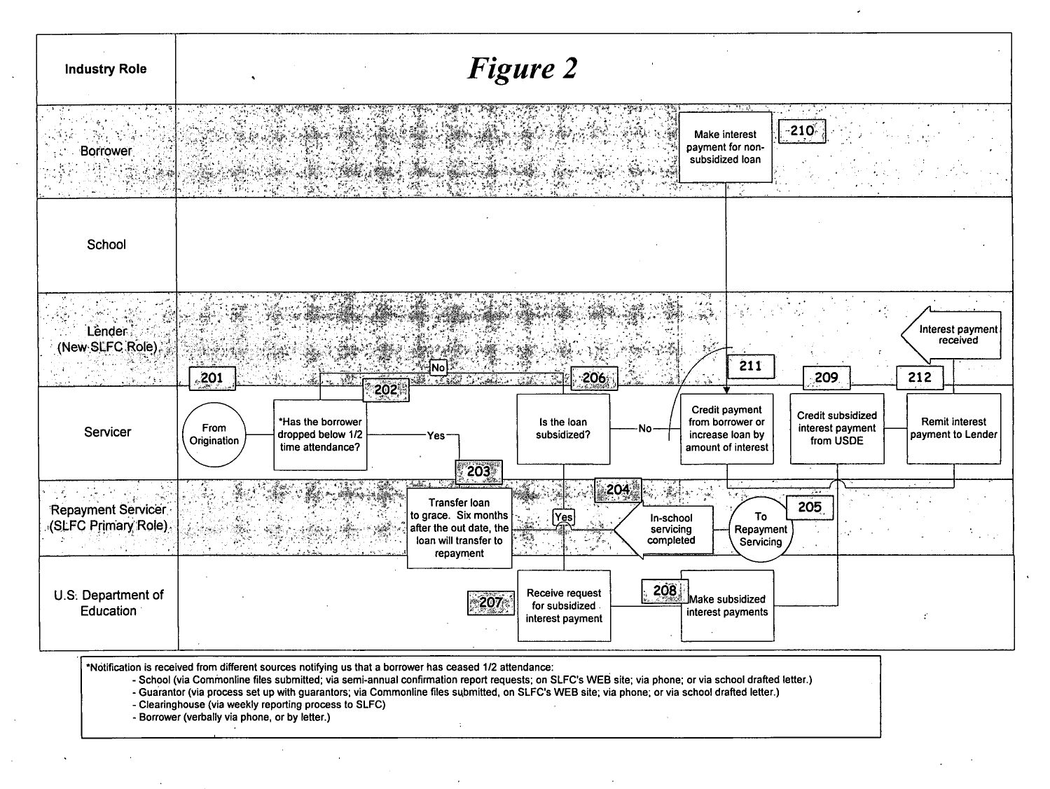

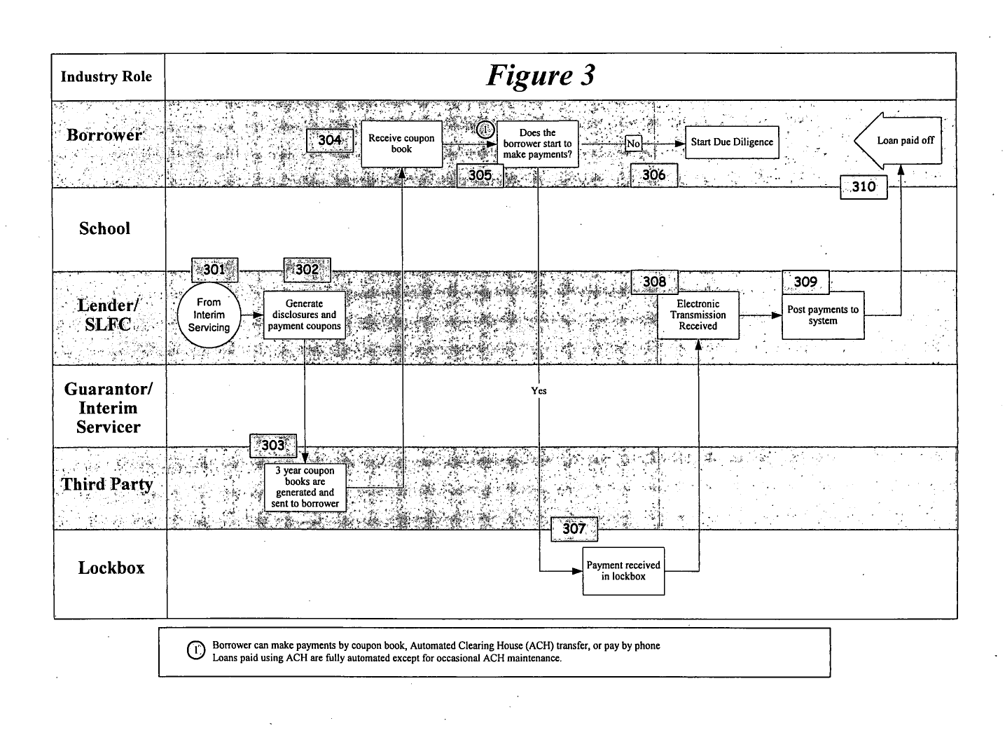

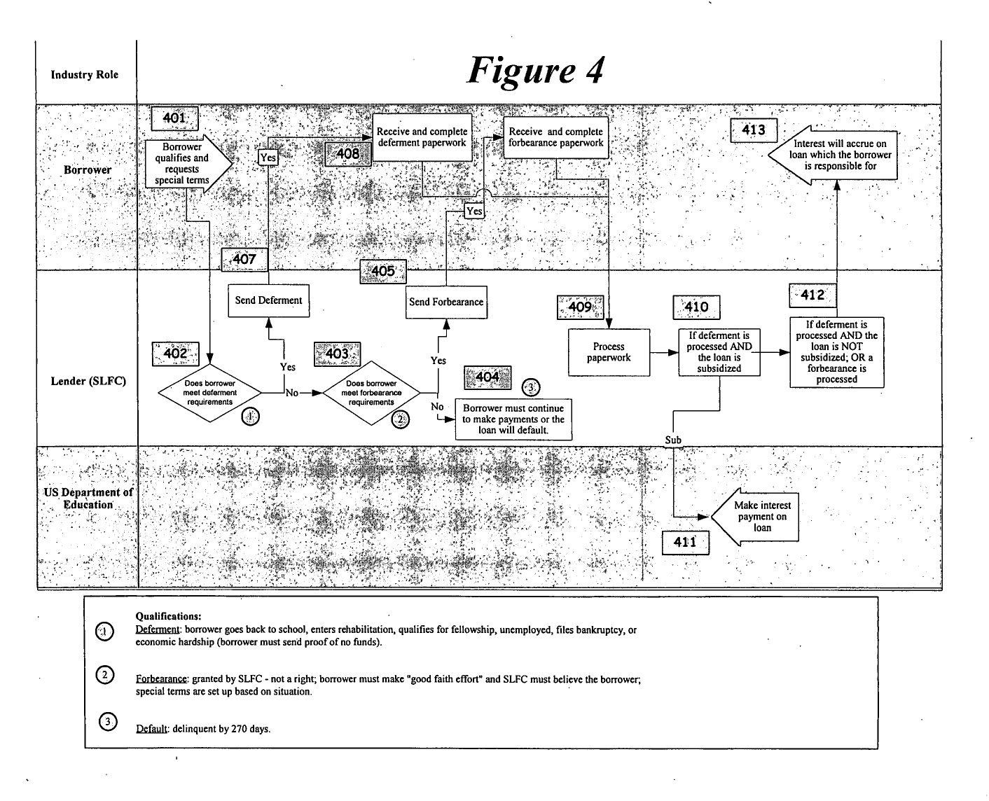

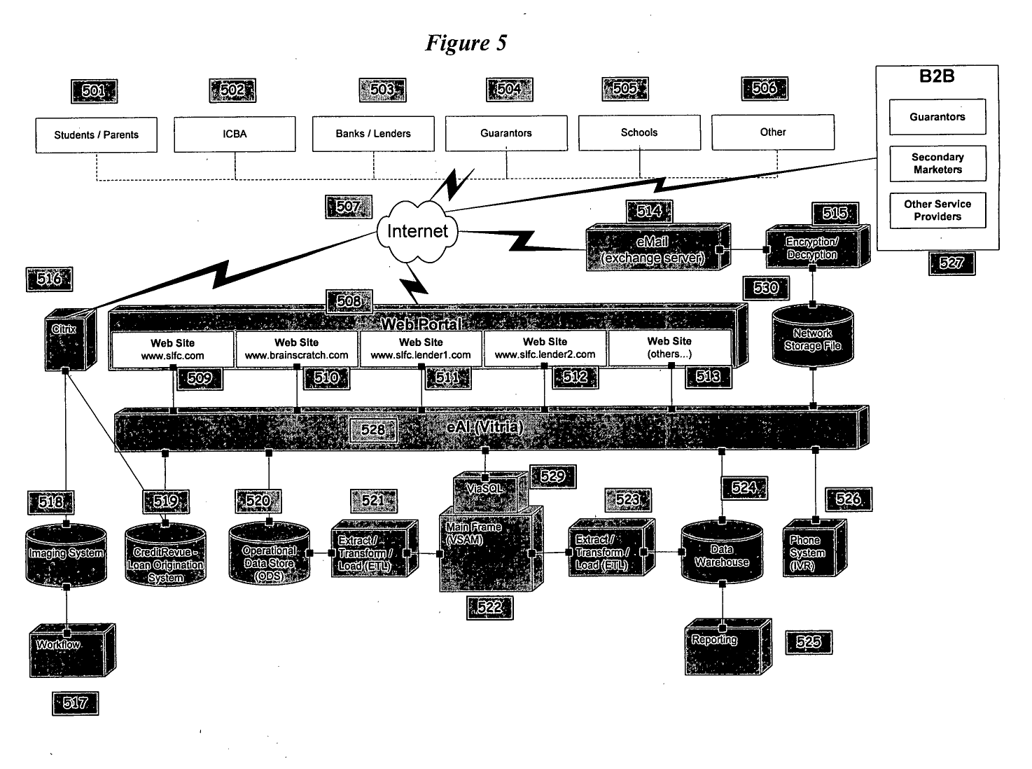

The system and methods of the present invention include the ability to originate loans (shown in FIG. 1), tracking and processing of information related to loans in an interim phase (shown in FIG. 2), transferring of and servicing of loans in a repayment status (shown in FIG. 3) and implementation of a method of offering and processing deferment and forbearance forms requested by a borrower during the repayment period (shown in FIG. 4). FIG. 5 is a block diagram for a system for processing loans according to the invention. Monitoring of the loans and accessing of the information related to the loans may be performed during all of these phases. The system is configured to connect itself, borrowers 501, ICBA 502, banks/lenders 503, guarantors 504, schools 505, and others involved in the loan process 506 through the Internet 507.

The system may be implemented with components or modules. The components and modules may include hardware (including electronic and/or computer circuitry), firmware and/or software (collectively referred to herein as “logic”). A component or module can be implemented to capture any of the logic described herein.

The borrowers 501 include students and/or parents, including co-signers, responsible for the repayment of the loan. The schools (a third-party recipient) 505 includes all departments, e.g., student aid, business office, registrar, etc., of the educational institution to whom the loan proceeds are disbursed. The guarantors 504 include agencies that administer the loan guarantee program by providing a federal guarantee for loans and agencies that direct the lender to proceed with loan disbursements. An example of such a guarantor is the Education Assistance Corporation (EAC). The banks/lenders 503 include financial institutions initially funding the loan.

The originators include parties originating the loan under the lender's name and provide interim servicing of the loan through “final disbursement” or until the loan is about to enter repayment. An example of an originator is EASCI (a subsidiary of EAC). Secondary marketers, such as Student Loan Financial Corporation (SLFC), include holders/owners of student loans that have been purchased from the original lender. Repayment servicers, such as SLFC, include organizations servicing student loans that have been fully disbursed or about to enter a repayment status. Other repayment servicers include organizations servicing loans owned by SLFC where SLFC is not handling repayment servicing (e.g., Great Lakes Higher Education Corporation).

The system includes three components that are connected to the Internet 507. These components include a business interface module 516, a web portal module 508 and an exchange server module that sends and receives e-mails 514. The web portal 508 includes web sites 509-512. The other web sites 513 are outside parties who have direct links to utilize processes on the SLFC.com web site. The e-mail module 514 is connected to an encryption/decryption module 515 that decrypts incoming e-mails and encrypts outgoing e-mails and places the incoming e-mails on the network storage file module 530. In turn, the network storage file module 530 as well as web portal 508 and web sites 509-513 are connected to a business process (e.g. eAI/Vitria) module 528. Business interface (e.g. Citrix) module 516 is connected to imaging system 518 and imaging system 518 is connected to workflow module 517.

The business process module 528 is connected to credit review/loan origination module 519, operational data store module 520, ViaSQL module 529, data warehouse module 524, and phone system 526. ViaSQL module 529 is front end software used to communicate with the mainframe module 522 and to convert data into a usable format to/from the main frame module 522. A separate reporting tool, business objects module 525, is connected to the data warehouse module 524 to extract data for trending reports, forecasting, and follow-up on existing processes. The operational data store (ODS) module 520 is updated with data from the loan origination module 519 and mainframe 522 in real-time, via Vitria. The ODS module 520 and data warehouse module 524 are updated from nightly batch run processes via the extract/transform/load (ETL) modules 521, 523.

Business to Business (B2B) module 527 may be implemented to connect the system directly with electronic data systems of guarantors, secondary markets or other service providers. B2B module 527 may be implemented with off the shelf B2B software which is then tailored to the specification of the system of the present invention.

The borrowers 501, Independent Community Bankers of America (ICBA) 502, banks/lenders 503, guarantors 504, schools 505, and others involved in the loan process 506 represent groups and entities involved in a loan process. This also includes lenders and borrowers as well as third parties such as guarantors and creditors. These entities and the system of the present invention, which is also part of the loan process, are brought together through the use of the Internet 507 or other information communication mediums, business interface module (Citrix) 516 or e-mail 514.

The web portal 508 is one of the interfaces between those involved in the loan process and the present invention. One embodiment of web portal 508 is a series of web pages and web domains, which allow entities outside the system to interface with the system. For instance, the web pages may provide secure pages for those entities involved in the loan process to input, retrieve or view data related to the loan process. Such data related to the loan process includes loan application data, school data or lender data. Web portal 508 also allows for application data modifications to specific data by the data's affiliated school and/or lender.

The web sites 509-512 provide functionality to a portion of the web portal 508. Web sites 509 and 510 provide real-time interfaces for borrowers to view their current data, modify pieces of that data, request forms, and apply for education loans. Web sites 511 and 512 may be established with the look and feel of integrated lenders' web sites and interface with the ODS system 520 (via Vitria) to provide interfaces for borrowers and other entities to view current loan data, modify pieces of that data, request forms, and apply for education loans. Additionally, other web sites 513 have links to the SLFC web site 509 to provide their borrowers a means of applying for education loan applications. The web sites 509-513 also use security protocols and secure web pages to provide security for the information displayed and inputted on and into the web pages associated with the web sites 509-513. The information is displayed on a display module, such as a monitor and personal computer. Once entered by a user, data is sent from the portal module to other parts of the system.

Encryption/decryption module 515 encrypts messages to other entities involved in the loan process and decrypts messages from those entities. The encryption and decryption may be performed with RSA or any other secure information transmission system. The encryption/decryption module 515 operates in conjunction with e-mail module 514. E-mail module 514 receives e-mails from and sends e-mails to those involved in the loan process. If these e-mails require encryption or decryption, then the e-mails pass through encryption/decryption module 515. Both of these modules are implemented with Visual Basic software written to perform these functions.

Business interface (Citrix) module 516 also provides an interface with the Internet 507 or a separate private line. The module allows the customer to directly interact with the imaging system 518 and the credit review module 519 with Citrix or similar software.

The business process module 528 provides an interface between the web portal 508 and other parts of the system of the present invention. The business process module 528 provides the interfaces between the components of the system and, in one embodiment, uses software titled Businessware. It possesses and is programmed with the knowledge of the functions and data formats of the other components of the system. The business process module 528 is thus able to integrate the various components of the system as well as allow real-time messaging between components of the system with different data formats by converting one data format into a second data format. Further, the business process module 528 also includes knowledge of the formats used by others in the loan process and is able to convert formats usable by components of the system to and from formats usable by others in the loan process. Such format data is kept in an internal loan reformatting and translation module (which also may be external to the business process module). When a new component is added to the system of the present invention, or when a new entity involved in the loan process is added to the capabilities of the system, an update to the business process module 528 allows for ease of integration of the new component or entity. The integration may be implemented by adding the formats expected to be used by the new component or entity to the business process module's 528 knowledge, which will allow for the translation of the new component or entity's expected format to and from those formats already in the business process module's knowledge. The integration of the new component or entity may also involve adding new process steps to allow for the special requirements of the new component or entity. An example would be adding a new step of checking residency to the loan origination phase for a government loan, if the government mandated the step.

Credit review/loan origination module 519 provides the system with the functionalities to implement loan origination and credit review procedures. The module implements the origination flow described below. The module also provides interface logic to the other entities involved in the loan process. Among other functionalities, the module is able to receive and process new loan applications from a borrower in real-time via the Web. The module also receives loan information from a school, lender, guarantor or loan intermediary via CommonLine files that have passed through a decryption process and Vitria transformation. The module creates new loan application files, schedules approval of loans, schedules disbursements of loans and other functions. The module also includes parameters for the manual inputting of data, correction of data, and approval of loans.

Operational data store module 520 stores information for the system. The information stored includes borrower information such as name, address, and all loan application data associated with the loan. The data store also includes loan information such as amount, loan status, school attended and due date. The operational data store module 520 may be located at the same site with the rest of the system, or may be at a remote location. If located at a remote location, the operational data store module 520 may be accessed through any system for information transmission, including a virtual private network (VPN). The operational data store module may cache data or use other speed enhancement techniques to lower the time for the operational data store to process and respond to a request for information.

Extract/transform/load (ETL) module 521 provides a means of transferring batch data accumulated from the mainframe module 522 to the operational data store module 520 or the data warehouse module 524. The ETL module 521 may also transform and transfer data received from external lenders to the main frame module 522, such as loan purchases.

ViaSQL module 529 provides a bridge between business process module 528 and mainframe module 522. The ViaSQL module allows business process module 528 to use SQL commands and routines to query the mainframe module 522 for information. The information may be stored in operational data store module 520 and/or data warehouse 524. The module also provides a bridge for the processing of specific transactions immediately on the mainframe that were originated on the Web or credit review module 519 and passed via Vitria. The module may be implemented with any type of database interface module such as a Siebel or Sybase database.

Mainframe module 522 is a central component of the system of the present invention. The mainframe module 522 includes several functions. These functions include the purchasing of loans from external creditors and performing the calculations that are used to process and keep loan data up to date. The module also creates processes to perform updates to others in the loan processing system. For instance, the mainframe module 522 implements processes to automatically send borrowers letters to provide the borrower his current loan status or to send the guarantor reports regarding the status of the loans the guarantor is guaranteeing. The mainframe module 522 also initiates the accumulation of data that will ultimately reside in the storage of loan data in the data warehouse module 524 and/or operational data store 520.

Data warehouse module 524 also stores information for the system. The information stored includes borrower information such as name, address, and other loan application data associated with the loan. The data stored also includes loan information such as amount, loan status and due date. The data stored in this module typically relates to reporting of loans and loan status. The data warehouse module also stores historical and archival records of the loan data.

Business objects reporting module 525 develops loan reports from the data warehouse. The module also allows for access of the data from the data warehouse by an administrator.

Phone system and interactive voice response system 526 allows for users to dial into the system and obtain loan information. The interactive voice response (IVR) system prompts users for information about the type of data to retrieve and then retrieves and reports the data back to the user instantaneously.

Workflow module 517 streamlines manual paper flow processes. All documents received in a mail center are imaged and put into the workflow module. The documents are then routed to the appropriate loan servicing staff to either respond to or to process. The information includes images of relevant documents that are stored on the imaging system 518, such as deferment or forbearance forms, skip trace documentation, and all correspondence from borrowers and schools.

Imaging system 518 interfaces with a business interface (Citrix) module 516 and workflow module 517. Imaging system 518 allows for the creation and storage of images of records such as loan applications. This system may be embodied as a set of scanners connected to a database. The imaging system may also create PDFs or other image based data by converting web-based application data into the appropriate format.

The system allows several methods related to the loan process to be performed within it. These methods include loan origination, interim monitoring and loan repayment methods implemented at least partially with a computer system. The system also provides for monitoring of the various phases of the loan process as well as components of the system to ensure accuracy in the loan processes.

A method of the present invention includes a loan origination process that may be implemented with an origination/credit review module. Steps included in the method are described in FIG. 1. The method involves interactions of borrowers, schools, originators, guarantors and others with a computer system.

The steps of the method are as follows. The borrower determines that he would like to request funds to attend a school 101. At this point, the borrower has three options. First, the borrower may complete an online loan application on a web site provided by SLFC, such as those of SLFC.com or BrainScratch.com 102. Second, the borrower may complete an on-line loan application on a web site that is linked to SLFC's web site or complete a loan application on a web site, such as one operated by a commercial bank, which is then e-mailed to SLFC. The application may also be sent through the portal to be stored by the system. Last, the borrower may choose to apply for a loan on paper 104, and provide this information to the school the borrower wishes to attend. To apply for a loan on paper, the borrower may perform steps, including filling out a paper master promissory note (MPN), selecting a lender, selecting a school and signing the form.

If the borrower chooses to fill out a paper loan application 104, then the school will enter the application information into a computer system 105 when it receives the application. At this point the computer system may either send the loan application to a guarantor directly 106 or create a new application in the origination system 108. Either process utilizes the CommonLine (CL) electronic application process and causes the loan application to be stored in a database module of the system.

If the borrower chooses to fill out a loan application on the web 102, 103 then the loan application is converted to a new application in the origination system 108. If the loan application is filled out on a web site provided by SLFC 102, then the application may first be converted by internal processes 107 into a file format usable by the present invention and then sent to the origination system 108. These web sites are part of the portal to the system.

Once the new application is created in the origination system 108, data files are created, a school certification request is filed, and a guarantee request is created 109. When the school receives a certification request it will certify the loan data, assign disbursement dates, assign disbursement amounts 110, and then send that information back to the loan originator (the creator of the certification request). After the loan has been certified, a guarantee request is submitted to the guarantor. When the guarantor receives the guarantee request, it guarantees the request and provides an approved disbursement schedule 111. The guarantor then sends this information back to the originator utilizing the CommonLine electronic application process. At that point, the originator allows for the disbursement of the finds 112 in the format requested by the school.

The originator provides information, passed as a CL file, to both the school and a central disbursing agent (CDA) such as Electronic Loan Maintenance National Disbursement Network (ELM NDN), if the school uses a CDA process. The ELM NDN then disburses the funds to the school's lender 113 and informs the school of the disbursement with a standard CL file. If the school utilizes either a master check or individual check process, a disbursement report is generated via the credit review module and mailed to the school with the check(s) enclosed. If the school utilizes an EFT (electronic funds transfer) process, the loan is pre-disbursed, a roster is mailed to the school, and the funds are deposited into the school's bank account using an automated clearing house (ACH) process on the disbursement date.

At this point, the school receives the funds for the loan and disburses them to the borrower 114. The borrower then receives the requested funds 115. After all requested disbursements have been made, the loan moves into the interim phase of processing data. The loan is archived in the origination system but remains as an active serviced loan on the SLFC mainframe system. The loan may be purchased by SLFC sometime between the first disbursement date and 60 days prior to the loan entering repayment status, depending on the contract agreement that SLFC has with the originating lender. Further, the information relating to loan is stored at each step in the system's databases. Each of the steps in the process of creating a new application causes an update to the loan data in a database module when the step is reported to or from the system, whether via e-mail or the portal.

Another method of the present invention also allows for improved interim loan processing that may also be implemented with a loan servicing module. FIG. 2 is a flow diagram of a method for an interim loan process. Interim loan processing commences after the origination of a loan completes. For each step in the interim process, an update to the loan data is performed in a database module when the step is reported to or from the system, whether via e-mail or the portal.

After the loan origination process completes 201, the loan servicing department periodically or the system automatically determines if the borrower changed his enrollment status or anticipated graduation date. This determination could also be based on other criteria such as information received from the borrower, school, or guarantor. The student will remain in interim status until his attendance falls below half-time, at which point the loan is put into a grace period. The grace period runs for a period of six months from the date the attendance fell below half-time 203. During the grace period, interim servicing will continue until the loan enters repayment, at which point the in-school servicing of the loan will be completed 204. The loan is then marked for repayment servicing 205.

Next, in the interim process, a determination is made by the system as to whether the loan data indicate that the loan is subsidized 206. If the loan is subsidized, the system sends a request via e-mail or the portal to the government asking for a subsidized interest payment 207. The government makes the subsidized payment to the servicer of the loan 208, and the payment is received by the servicer 209. If the loan is not subsidized, then the borrower has the option of making interest payments on the loan 210. The servicer in turn either accepts the interest payment from the borrower or if the borrower does not make an interest payment, the servicer increases the amount of the loan by the amount of the interest when the loan transfers to repayment from a grace period 211. Once an interest payment is received from the government or a borrower, it is remitted to the lender 212. At each step of the interim process, the system updates its database with current loan data.

FIG. 3 is a flow diagram for a method for implementing a repayment process that may also be implemented with a loan servicing module. After completing the interim process 301, the loan is moved into the repayment process. Each of the repayment process steps causes an update to the loan data in a database module when the step is reported to or from the system, whether via e-mail or the portal. The lender generates disclosures and payment coupon books 302. The coupon books are sent to a third party 303 who in turn sends the coupon books to the borrower 304. If the borrower does not start making payments 305, then a due diligence process is begun 306. If the borrower does begin to make payments on the loan, the coupon instructs the borrower to mail the payment to a third party's lock box 307. The third party then provides the lender with an electronic transmission of the funds 308. Upon receipt of the transmission, the lender posts payments to the system 309. This process may be continued until the loan is entirely paid 310.

During the loan repayment process other issues may arise regarding the situation of the borrower, in which case the borrower may request a deferment or forbearance of repayment. FIG. 4 is a flow diagram for a repayment form request process that may also be implemented with a loan servicing module. These steps also cause an update to the system's database modules. A request for deferment or forbearance of repayment is made 401 through either written or verbal communication with the borrower. If the borrower meets the initial qualifications for a deferment 402, the appropriate deferment form is sent 407. If the borrower does not qualify for a deferment and meets the requirements for a forbearance 403, a forbearance form may be sent 405. If it is determined that the borrower does not qualify for a deferment or forbearance, the borrower continues to make payments 404. When the borrower returns the completed and signed deferment form 408, it will be processed and the loan extended for the length of time requested 409. If the borrower owes any payments as of the deferment start date, an administrative forbearance is processed to bring the borrower current before processing the deferment. If a deferment is processed on a subsidized loan, the government will be billed quarterly for the interest that accrues on the unsubsidized portion of the loan during the entire deferment period 411. If the borrower was not eligible for a deferment and is sent a forbearance, when the signed forbearance form is returned 408, it will be processed for all past due payments and any additional time agreed to between the borrower and lender 409. If the borrower is in a period of deferment and has unsubsidized notes or is in a forbearance, the interest that accrues during this time period accrues to the borrower 412. If the borrower does not choose to pay the interest during the deferment or forbearance, the interest will be capitalized when the deferment or forbearance ends and repayment resumes 413.

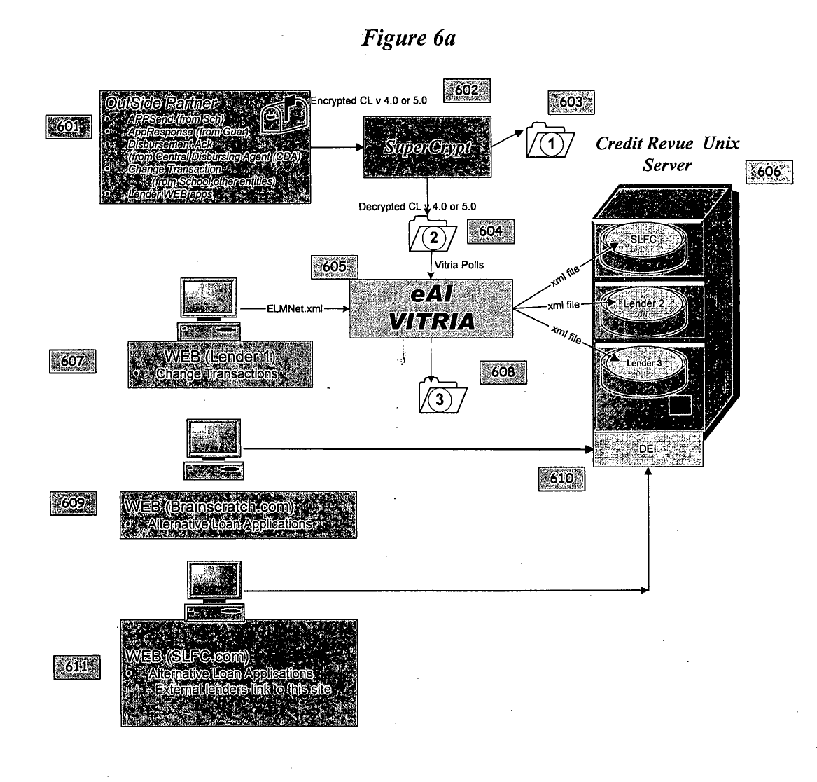

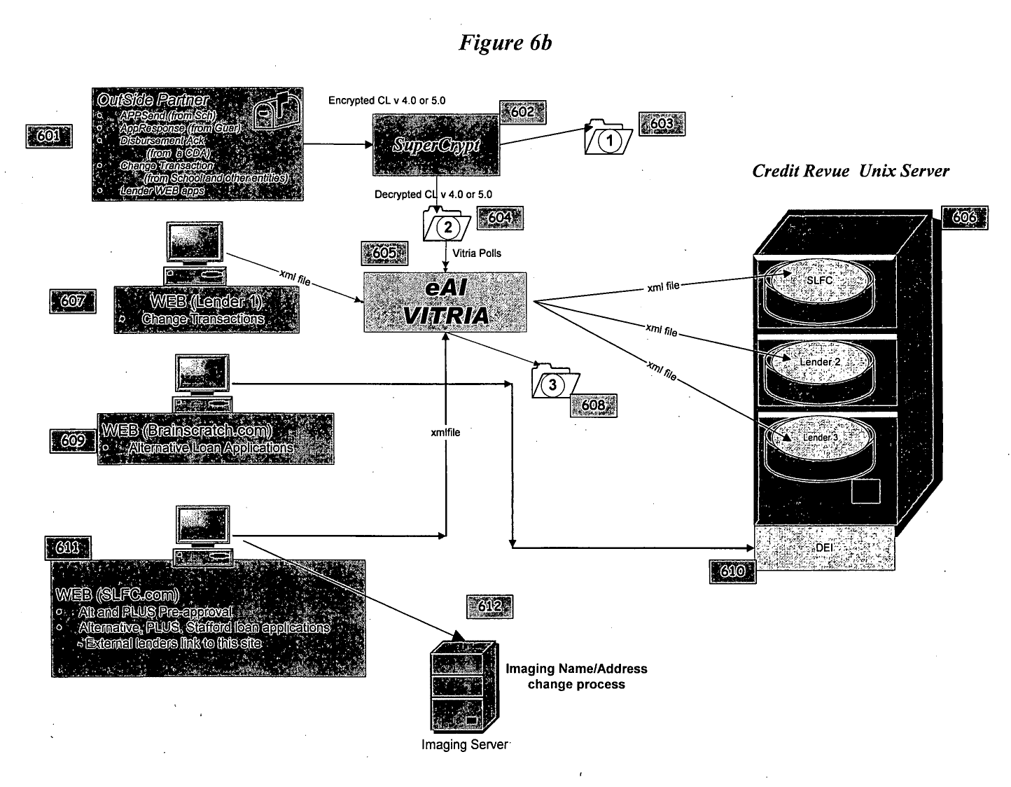

FIGS. 6a and 6b are two embodiments of process flows into a database and review system. An outside partner 601 is able to send Commonline files via e-mail to the system. This information includes loan applications from schools, application responses from guarantors, disbursement acknowledgments from third parties, change transactions from schools or other third parties, and applications from banks. The electronically sent information is generally encrypted when sent via e-mail. The SuperCrypt (Encryption/Decryption ) module 602 decrypts the incoming information and places the files in a folder on a network file storage database 603 for Vitria (business process module) 605 to pick up. A copy of the incoming files are also archived in a separate directory on this same database by SuperCrypt 602 for external lenders to be able to view 603.

The Vitria system polls the network directory 604, where Supercrypt has placed the files, every few seconds, searching for new files that have been placed in the directory for processing. Vitria will take the incoming data and transform them into files that can be received by the credit review/loan origination module. The files are then directed to the appropriate origination module based on the lender ID. A copy of the files Vitria creates to push into the credit review/loan origination module are archived in a directory for future reference 608. This process also allows schools the ability to modify specific loan information via their lender's Web portal and to have the data immediately updated on the customer's loan. The data is entered by the school through the portal. A separate file is created by the system and passed to Vitria 605 to process. Vitria pushes the file directly into the appropriate credit review/origination system (CR), based on lender identification, for processing 606. A copy of the file pushed into CR is also archived in a database 608.

Another entry point into the system is an alternative web portal 609. This portal creates a Web application in one embodiment using a file layout build by CMSI (a credit revue software vender), referred to as a data exchange interface 610 (DEI), to directly update the CR origination system 606. Additionally, another web portal 611 is integrated using the DEI system. This other web portal, in the embodiment of FIG. 6a, is connected to CR via the DEI 610, and in the embodiment of FIG. 6b, is connected to the Vitria system 605. Depending on the configuration being used, the other web portal 611 provides the outside entity to whom the system is connected with data in an expected format. An additional function in the embodiment of FIG. 6b is that a portal 611 is also connected to the imaging server 612, which allows for imaging server to automatically download and upload paper loan applications to and from an outside entity's system.

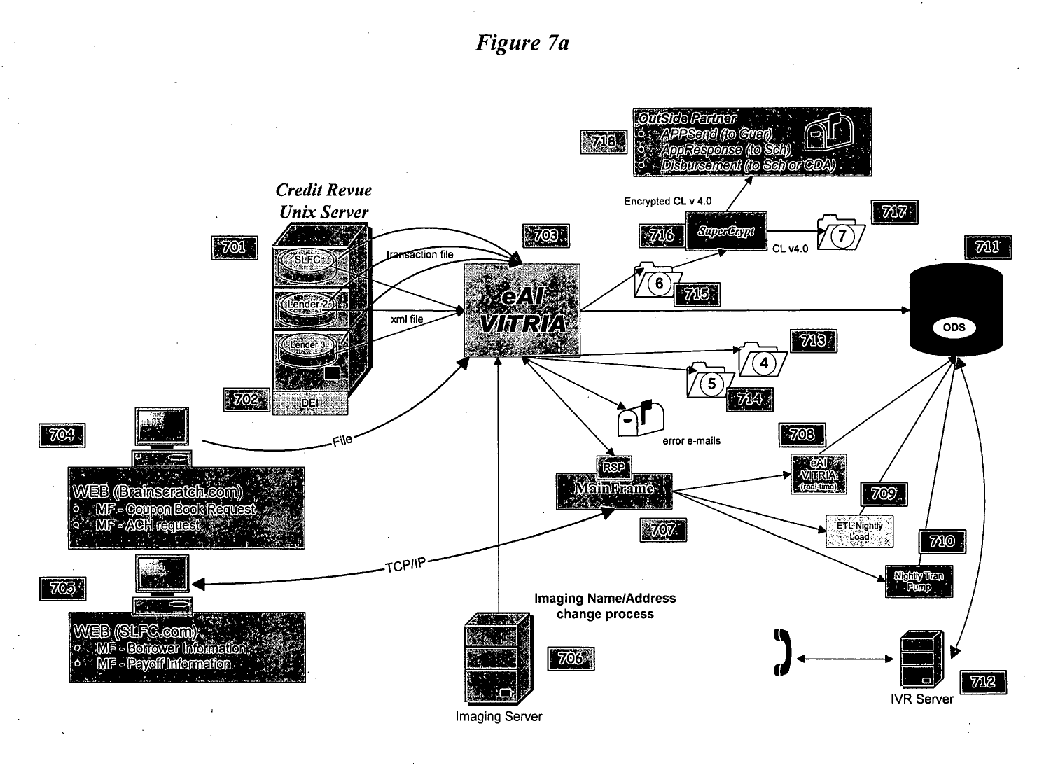

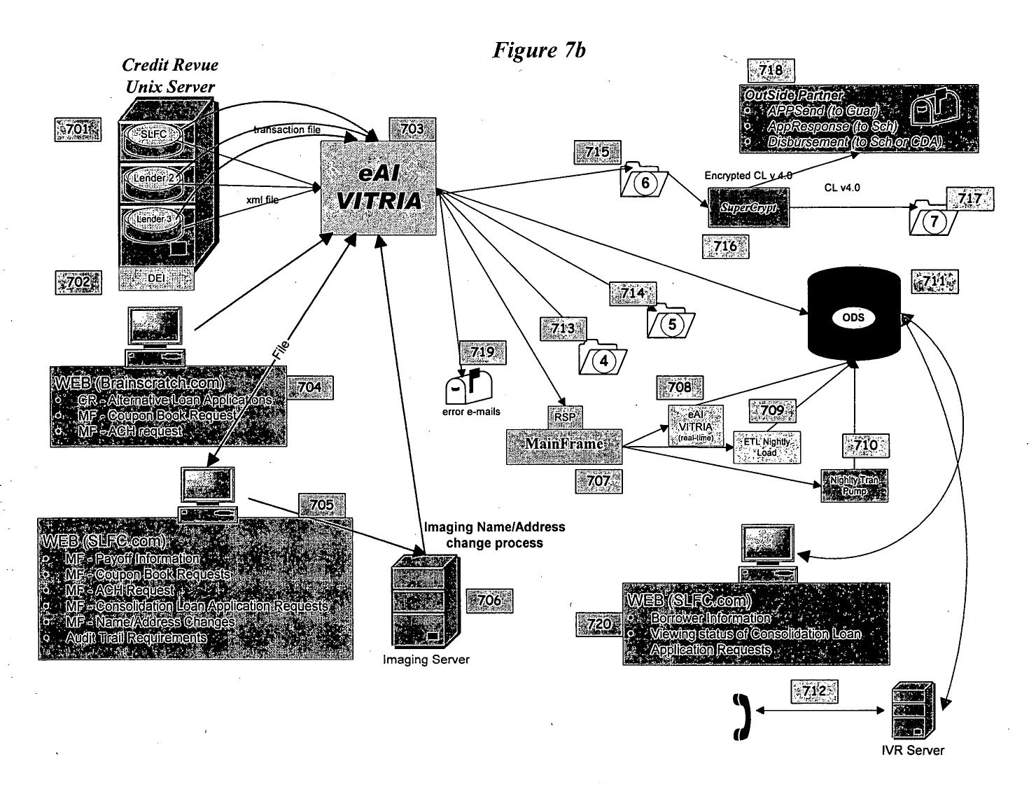

FIGS. 7a and 7b are diagrams illustrating dataflow into and out of the invention. When applications on the credit review origination module are added or modified, a file or data dump of CR tables and fields is produced that is placed in a separate directory (based on lender ID) on the CR Unix server 701. Vitria 703 will then poll three separate directories for files to process. When a name/address change is performed on any of the three CR systems, a separate file is created by CR and pushed to Vitria. Further, web portals 704 and 705 also allow interaction with the system. Web portal 704 may be configured to allow for the sending of alternative loan applications, coupon book requests and ACH requests to the Vitria system 703. In one embodiment, web portal 705 is connected to mainframe 707 via a TCP/IP connection. In a second embodiment, web portal 705 is connected to the Vitria system 703. The web portal 705 in one embodiment allows for the transmission of information, including the inquiry of borrower information and the request for a payoff amount. The web portal 705 in the second embodiment also allows the borrower to apply for automatic payment withdrawals, submit a coupon book request, submit Consolidation Loan Application requests, submit name/address changes and fulfill audit trail requirements.

In the first embodiment of FIG. 7a, the imaging server 706 has a name/address process that allows a system administrator to change a borrower's name or address and have it updated on the mainframe 707 via Vitria 703 in real-time. An additional element of the second embodiment of FIG. 7b, allows for the automatic downloading of application forms from the web portal directly into the imaging system. Further, Vitria receives data that is polled from the CR Unix Server 701. The data could follow multiple routes, depending upon the type of data changed and the required next step in the process. Also, a copy of a CR-Data.xml file, which holds credit review data, is archived in a database module 713. If there are XML file errors with respect to the CR system, then data are compiled into a report based on Lender ID and stored in a directory accessible to the lender 714. If there are CR-Data XML reference processes that are updated on the Mainframe 707, Vitria will pass the data to the appropriate Remote Stored Procedure (RSP) on the mainframe. If these processes create an error, an e-mail is sent to SLFC Loan Servicing area 719 for manual processing. If the XML calls for a CL file to be generated, the file is created by Vitria and passed into a directory 715 for SuperCrypt 716 to pick up.

SuperCrypt batches the CL files by entity, encrypts the files, and places them on the mail server to be e-mailed to the appropriate party 718. SuperCypt will also archive a copy of the CL file sent to an external entity in a folder that can be viewed by the affiliated lender 717. Items sent to outside partners include applications sent to guarantors, application responses sent to schools, and disbursements sent to schools or a CDA. The data from the XML file are also passed directly into the ODS 711 via Vitria. When data are added or modified on the mainframe system, it will also update the ODS 711.

There are three different processes that update the data on the mainframe. Some transactions are passed real-time via Vitria 708, some are batched together and sent via a nightly ETL load process 709, and other transactions are processed in a mainframe nightly run batch process and are passed through a nightly transaction pump process 710. The IVR (interactive voice response) server 712, which allows users to obtain information from the system over a telephone, is connected directly to the ODS system 711 to provide borrowers with real-time data. Finally, in the second embodiment of FIG. 7b, a borrower, via a web portal 719, is able to access his specific loan information, as well as view the status of any of outstanding loan application data, based on real-time data found in the ODS system 711.

The disclosure primarily describes the implementation of the present invention with respect to student loans. However, other types of loans may be implemented in accordance with the present invention, including consumer, home, corporate and vehicle loans. For instance, for auto loans, the system would incorporate car dealerships instead of schools and car-buyers instead of students. The system would also incorporate the agencies and other entities within the automobile loan industry similar to those agencies and other entities involved with the school loan industry.

Additionally, for home loans, home buyers may be incorporated into the system instead of students, and various home sellers may be incorporated in place of the schools. However, it will be noted that automobile, home and school loans may all be implemented on the same system by updating the process flows and the interfaces to the system (such as the web portal).

The system and method are also adaptable to transactions in general as loans are merely a type of transaction. Further, loan data is a subset of transaction records. To perform such an adaptation, the rules for performing the added transaction would be supplied to the business process module 528 of the system. The business process module 528 would then be able to manage the added transaction as well as the data flow for the added transaction.

The interconnections for the present invention may be accomplished through the use of the Internet or any other electronic or network communication means, such as the Internet, wireless, cellular, satellite, television or local area network. The interconnections for the present invention also include Bluetooth communications. For instance, a user may communicate with the system through a Bluetooth enabled device, such as a cell phone or personal digital assistant. The Bluetooth enabled device would then use a Bluetooth enabled portal to communicate with the system.

1. An interconnected system for managing loan records, including:
an encryption decryption module connected to an external data source, including logic configured to encrypt and decrypt data;
a loan reformatting and translation module connected to the encryption-decryption module, including logic configured to alter a first type of loan record into a second type of loan record;
a loan origination module connected to the loan reformatting and translation module, including logic configured to process and originate loans;
a database module connected to the loan reformatting and translation module, including logic configured to store loan account information;
a portal connected to the loan reformatting and translation module, including logic configured to allow internal users access to at least the loan reformatting and translation module; and
a loan servicing module connected to the loan reformatting and translation module, including logic configured to alter and process loan data;
wherein the portal is configured to provide guarantors, borrowers, third-party recipients and lenders access to the system for managing loan records.

2. The system of claim 1, wherein the loan servicing module includes servicing logic configured to perform repayment of a loan.

3. The system of claim 2, wherein the servicing logic is configured to implement:
a loan origination process;
a loan repayment process; and
an interim loan processing process.

4. The system of claim 3, wherein the servicing logic is configured to store loan data in an operational data storage module.

5. The system of claim 1, wherein the portal is configured to allow at least one of third-party recipients, borrowers, guarantors and lenders to access the system for managing loan records during any phase of operation.

6. The system of claim 5, wherein the portal is configured to interact with business to business software to connect to a loan process system of another business.

7. The system of claim 5, wherein the portal is connected to a business process module, including logic configured to coordinate the flow of data through the system.

8. The system of claim 1, wherein the loan records include at least one of a commonline file and an XML file.

9. The system of claim 1, wherein the external data source includes at least one of wireless, cellular, satellite, Internet, television and local area network communications.

10. The system of claim 1, wherein the portal is a web portal.

11. An Internet-based electronic portal for managing financial transactions between persons, including:
a portal module connected to the Internet, including logic configured to receive communications from the Internet and to interact with display modules and information modules of multiple persons;
a display module connected to the portal module, including logic configured to display financial transaction data;
an interface module connected to the portal module, including logic configured to provide an interface to a financial transaction management system; and
a servicing module connected to the interface module, including logic configured to alter and process financial transaction data.

12. The Internet-based portal of claim 11, wherein the persons includes at least one of borrowers, schools, lenders, guarantors, originators, secondary marketers and repayment servicers.

13. The Internet-based portal of claim 1 1, wherein the servicing module includes logic to perform at least one of awarding financial aid, selecting a school, selecting a lender, executing a promissory note, submitting student loan information, pre-approving a loan request, guarantying a loan request and approving a guarantor.

14. The Internet-based portal of claim 11, wherein the servicing module includes logic to perform at least one of requesting a certification of a school, certifying a school, executing disbursement orders, disbursing funds and notifying a party of the disbursement.

15. The Internet-based portal of claim 11, wherein the servicing module includes logic configured to perform at least one of purchasing a loan from a lender, transferring student loan files and performing repayment services.

16. The Internet-based portal of claim 11, further including a management module connected to the interface module, including logic configured to perform at least one of accessing student loan information and processing student loan file information.

17. The Internet-based portal of claim 11, wherein the portal module includes logic configured to perform at least one of authenticating persons, authorizing persons, presenting data, routing messages, accessing a data store, accessing a data warehouse, accessing images of documents, and accessing a query report tool.

18. The Internet-based portal of claim 11, wherein the communications from the Internet are received via at least one of wireless, cellular, satellite, television and local area network communications.

19. An Internet-based method for managing financial transactions between persons through a portal on a system for managing loan records, including the steps of:
commencing a financial transaction in an origination phase;
maintaining the financial transaction in an interim phase;
ending the financial transaction in a repayment phase;
displaying the status of the financial transaction to a user in any of the phases; and
allowing, during any phase, access through the portal to the system for managing loan records by guarantors, borrowers, third-party recipients and lenders.

20. The method of claim 19, wherein:
the financial transactions include student loans; and
the persons include at least one of borrowers, schools, lenders, guarantors, originators, secondary marketers and repayment servicers.

21. The method of claim 20, wherein the commencing phase includes at least three of the steps of:
awarding financial aid;
selecting a school and a lender;
executing a promissory note;
submitting student loan information;
requesting loan pre-approval;
determining the loan;
controlling the student loan file;
guaranteeing the request;
guaranteeing the approval; and
notifying at least one of the guarantors.

22. The method of claim 19, wherein the commencing phase includes at least two of the steps of:
requesting a school certification;
certifying a school;
executing disbursement orders;
disbursing funds;
disbursing notifications; and
performing interim service interactions.

23. The method of claim 19, wherein the repayment phase includes at least two of the steps of:
purchasing a loan from a lender;
transferring a student loan file; and
performing repayment servicing interactions.

24. The method of claim 19, wherein the interim phase includes the steps of accessing student loan information.

25. The method of claim 19, wherein the interim phase includes the steps of:
determining the continuing qualification status of a person;
determining a grace period for the transaction;
determining subsidies for the transaction; and
receiving subsidized payments for the transaction.

26. A method of performing a loan origination process though a portal on a system for managing loan records, including the steps of:
completing a loan application by a borrower on a web site and sending the loan application to a loan processing system via the portal;
sending the loan application by the loan processing system to a school via the portal;
distributing the loan application by the loan processing system to guarantor via the portal;
storing a copy of the loan application in the loan processing system;
obtaining a loan guarantee for the loan application from the guarantor via the portal;
disbursing funds by the loan processing system automatically to the borrower; and
allowing access through the portal to the loan processing system by guarantors, borrowers, third-party recipients and lenders.

27. A method of controlling a loan interim process though an Internet-linked portal on a system for managing loan records, including the steps of:
determining by a servicer if the borrower is in a loan grace status; and
sending a message via the portal to an Internet-linked system to inform the system of the status of the borrower;
transferring the loan to a repayment process after a set period of time if the borrower is in a loan grace status;
determining by the Internet-linked system if the loan is subsidized if the borrower is not in a loan grace status; and
allowing during access through the portal to the system for managing loan records by guarantors, borrowers, third-party recipients and lenders.

28. The method of claim 27, wherein if the Internet-linked system determines that the loan is subsidized, performing the steps of:
requesting a subsidy from the subsidizing agency through the portal;
receiving a subsidy confirmation from the subsidizing agency through the portal;
applying the subsidy by the Internet-linked system to the loan; and
sending an interest payment to the lender via the portal.

29. The method of claim 27, wherein if the Internet-linked system determines that the loan is not subsidized, performing the steps of:
performing at least one of increasing a loan amount and receiving a payment from a borrower through the portal; and
sending an interest payment to the lender via the portal.

30. A method of controlling a loan repayment process though an Internet-linked portal on a system for managing loan records, including the steps of:
generating disbursement and payment coupons by an Internet-linked system;
sending a borrower a coupon book;
receiving payments from the borrower;
recording payment from the borrower in the Internet-linked system; and
allowing access through the portal to a system for managing loan records by guarantors, borrowers, third-party recipients and lenders.

31. The method of claim 30, wherein the payments are received via the portal.

32. An interconnected system for managing loan records, including:
Internet connection means for integrating a loan management system to the Internet, including an Internet connection module;
encryption and decryption means for coding messages connected to the Internet connection mean, including logic configured to encrypt and decrypt information received by the encryption and decryption means;
loan reformatting and translation means for changing format between systems connected to the encryption and decryption means, including logic configured to alter at least one first file format into at least one second file format;
loan origination means for creating loan data connected to the loan reformatting and translation means, including logic configured to originate loan information for at least one borrower;
storage means for storing the loan data connected to the loan reformatting and translation means, including logic configured to store data for at least one loan account;
web portal means for interfacing with the Internet connected to the loan reformatting and translation means, including access logic configured to allow guarantors, lenders, borrowers and third-party recipients access the system for managing loan records; and
loan servicing means for altering the loan data connected to the loan reformatting and translation means, including logic configured to alter data in at least one loan account.

33. An interconnected system for managing loan records, including:
an encryption-decryption module connected to a web portal module, including logic configured to encrypt and decrypt loan data;
a loan reformatting and translation module connected to the encryption-decryption module, including logic configured to alter a first type of loan record into a second type of loan record;
a loan origination module connected to the loan reformatting and translation module, including logic configured to process and originate loans;
a database module connected to the loan reformatting and translation module, including logic configured to store loan account information;
the web portal module connected to the loan reformatting and translation module and business process module, including logic configured to allow internal users access to the system for managing loan records and logic configured to coordinate the flow of data through the system, wherein the web portal module is configured to provide guarantors, borrowers, third-party recipients and lenders access to the system for managing loan records during each phase of operation and supports at least one of Internet, wireless, cellular, satellite, television and local area network communications; and
a loan servicing module connected to the loan reformatting and translation module, including processing logic to implement a loan origination process, implement a loan repayment process, implement an interim loan processing process and store loan data in an operational data storage module.

34. An electronic method for managing financial transactions between persons through a portal on a system for managing transaction records, including the steps of:
commencing a financial transaction in an origination phase;
maintaining the financial transaction in an interim phase;
ending the financial transaction in a finalization phase;
displaying the status of the financial transaction to a user in any of the phases; and
allowing, during any phase, access through the portal to the system for managing loan records by guarantors, borrowers, third-party recipients and lenders.

35. The method of claim 34, wherein:
the financial transactions include student loans; and
the persons include at least one of borrowers, schools, lenders, guarantors, originators, secondary marketers and repayment servicers.

36. An interconnected system for managing transaction records, including:
an encryption decryption module connected to an external data source, including logic configured to encrypt and decrypt data;
a data record reformatting and translation module connected to the encryption-decryption module, including logic configured to alter a first type of transaction record into a second type of transaction record;
a transaction origination module connected to the data record reformatting and translation module, including logic configured to process and originate transactions;
a database module connected to the data record reformatting and translation module, including logic configured to store transaction information;
a portal connected to the data record reformatting and translation module, including logic configured to allow internal users access to at least the data record reformatting and translation module; and
a transaction servicing module connected to the data record reformatting and translation module, including logic configured to alter and process transaction data;
wherein the portal is configured to provide at least on entity involved in a transaction access to the system for managing loan records.

37. An Internet-based method for managing student loan data between at least one of guarantors, schools, lenders, guarantors, originators, secondary marketers and repayment servicers, including the steps of:
commencing a student loan in an origination phase, the commencing step including the steps of:
awarding financial aid;
selecting a school and a lender;
executing a promissory note;
submitting student loan information;
requesting loan pre-approval;
determining the loan;
control the student loan file;
guaranteeing the request;
guaranteeing the approval;
notifying the guarantee;
requesting a school certification;
certifying a school;
executing disbursement orders;
disbursing finds;
disbursing notifications; and
performing interim service interactions;
maintaining a student loan in an interim phase, the maintaining step including the steps of:
accessing student loan information;
accessing other student loan financial information.
determining the continuing qualification status of a person;
determining a grace period for the transaction;
determining subsidies for the transaction; and
receiving subsidized payments for the transaction;
ending a student loan in a repayment phase, the ending step including the steps of:
purchasing a loan from a lender;
transferring a student loan file; and
performing repayment servicing interactions; and
displaying the status of the financial transactions to a user in each of the phases.
